(19) United States
(12) Patent Application Publication
(10) Pub. No.: US 2008/0135272 A1
(43) Pub. Date: Jun. 12, 2008

(54) Battery Energized Portable Power Tool

(76) Inventor: Carl Johan Erik Wallgren, Stockholm (SE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/795,325

(22) PCT Filed: Nov. 17, 2006
(86) PCT No.: PCT/SE06/01304

§ 371 Date: Jul. 16, 2007

(30) Foreign Application Priority Data
Nov. 17, 2005 (SE) 0502523-4

(51) Int. Cl. B25F 5/00

(52) U.S. Cl. 173/217

(57) ABSTRACT

A battery energized portable power tool has a pistol type housing with a connector for attachment of a replaceable battery unit, and an upgrading module insertable between the housing and the battery unit and being provided with accessories for adding extra operational features to the tool for meeting specific demands for different tool applications, for instance a transceiver for wireless signal communication with a stationary control unit.

The invention relates to a portable power tool energized by a replaceable battery unit, wherein the battery unit is connected to the power tool via a connection means comprising matching electric connector elements for establishing electric communication between the battery unit and the power tool.

A problem inherent in portable power tools is the limited space available to fit accessories that may be required for the actual tool specification, and not only that, different tool applications demand differently equipped tools, which means that almost every power tool delivered by the tool supplier has to be specially adapted to an individual specification. This means that each power tool has to be specially designed with a specific setup of accessories providing desired operational features, with the result that the manufacturing costs for the power tools tend to be rather high.

A solution to this problem is to offer a few basic models of the power tool and a number of upgrading modules which comprise different sets of accessories to meet different power tool specifications and which are easily attachable to the tool. Each power tool order may then contain a basic power tool model and an upgrading module comprising all the accessories required to meet the actual tool specification. Such a system build-up is previously described per se in connection with cable connected power tools. See U.S. Pat. No. 6,821,157.

Compared to cable connected electric tools, the above described type of power tools is also faced with the problem of communicating electric signals to and from a remotely located stationary control unit, signals that relate to governing the tool operation and/or reporting back from the tool actually experienced parameter values during operation.

This has been solved by employing radio communication between the power tool and the control unit, as described in for instance U.S. Pat. No. 6,845,279.

It is the main object of the invention to accomplish a battery energized power tool with an upgrading module system by which the adaptability of a power tool to different desired specifications is increased in combination with a cost saving flexibility for the tool manufacturer who will be able to offer power tools with a wide range of specifications based on just a few basic tool models.

The power tool upgrading module system according to the invention means, for instance, that a battery energized power tool easily may be provided with a radio communication means for communicating electrical signals to and from a stationary control unit, without complicating the design of the power tool itself.

A preferred embodiment of the invention is below described in detail with reference to the accompanying drawings.

In the Drawings:

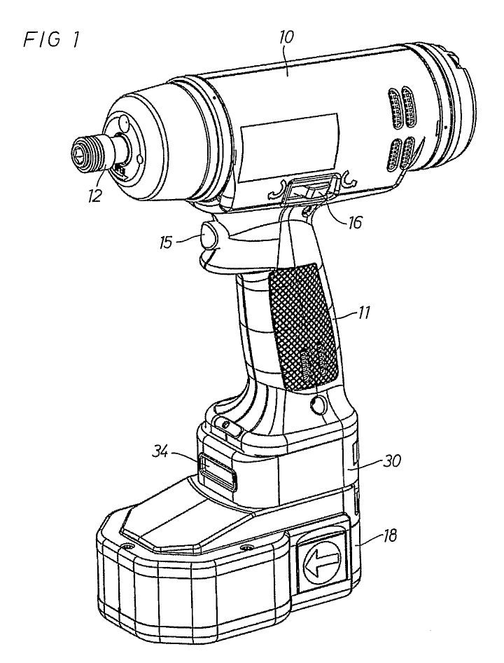

FIG. 1 shows a perspective view of a power tool according to the invention.

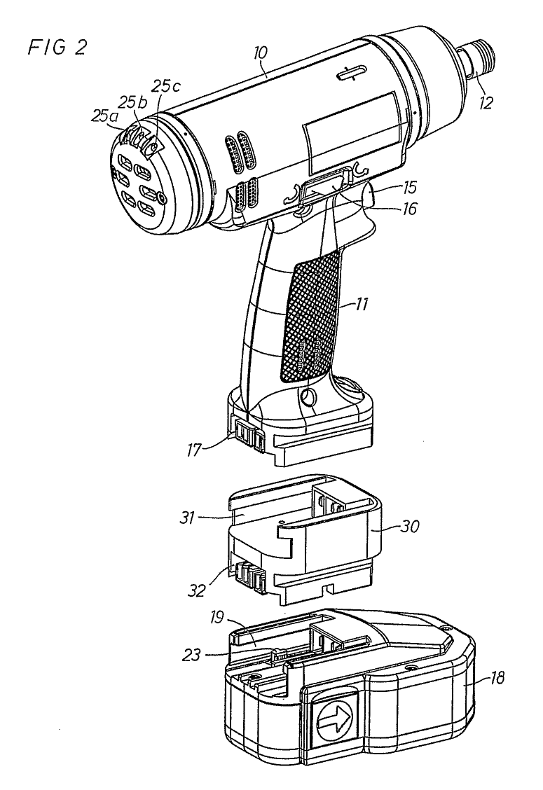

FIG. 2 shows an exploded view of the power tool in FIG. 1 with the battery unit and upgrading unit detached.

The power tool shown in the drawing figures is a battery powered pistol type screw driver which comprises a housing 10 with a handle 11, an electric motor coupled to an output shaft 12. On the housing 10 there is supported a power control button 15 and a forward/reverse mode shifting switch 16.

In a conventional manner in this type of tools, the lower end of the handle 11 is provided with a connection means 17 for attaching a battery unit 18 with a matching connection means 19. The battery unit 18 is of a standard type used for this type of electric tools. These connection means 17,19 comprise electrical connectors for communicating electric power from the battery unit 18 to the power tool motor. There is also provided a quick coupling type lock device 23 for retaining the battery unit 18 relative to the housing 10. Accordingly, the battery unit 18 is readily replaceable by another fully charged battery unit when needed without removing the upgrading module 30 from the handle 11. In order to more safely secure the upgrading module 30 to the tool housing there is suitably added a more reliable retaining means, for instance a threaded fastener.

The tool may also be provided with sensors (not illustrated) for sensing different operation parameters like delivered output torque and battery unit charge level. These sensors are connected to a number of signal lights 25 a-c by which the operator is informed when the delivered output torque of the screw driver has/has not reached the intended final torque level, i.e. whether the screw joint has been acceptably tightened, and when the charge level of the battery unit 18 has dropped below a certain level calling for a replacement by a fresh and fully charged unit.

According to the invention the tool is provided with a replaceable upgrading module 30 which is insertable between the battery unit 18 and the handle 11 and which is provided with connection means 31 and 32 for matching with the connection means 17,19 on the handle 11 and the battery unit 18. A quick coupling type lock device is provided on the upgrading module 30 for retaining the latter relative to the handle 11. This upgrading module 30 is individually designed to meet the specific demands of a particular tool application and/or a particular tool operator, and contains additional features as for instance a transceiver for radio communication with a non-illustrated stationary tool operation control and monitoring unit located at the working site. By such wireless communication it is possible to control the tool operation in accordance with certain desired screw joint tightening strategies. Other accessories or features that may be added to the tool via the upgrading module 30 are tool positioning means for determining the actual tool position relative to a working object, and extra warning lights and/or buzzers to inform the operator of certain operation conditions. The upgrading module 30 may also be provided with a working object identifying scanner 34. See FIG. 1.

The upgrading module 30 is one of a number exchangeable upgrading modules each one specifically designed to meet the particular needs of a certain tool application and/or operator desire. This gives the advantage of not having to specially design the power tools to the different operator/application demands for extra operational features. Instead, the power tools could be equipped with a basic level of features and added the extra features needed via a specially designed upgrading module.

In an alternative embodiment of the invention the upgrading module 30 may be permanently joined with the battery unit 18 and arranged to receive a power tool activating signal at each battery unit charging occasion, which would be effective in preventing misuse or theft of the tool. This means that there has to be a number of identical upgrading modules 30 each attached to a replaceable battery unit 18. Also in this embodiment there may be added a more reliable retaining means for securing the upgrading module 30 to the battery unit 18, for instance a threaded fastener.

At use of the power screw driver according to the invention the specially designed upgrading module 30 for the particular application is fitted to the tool handle 11 and is left there permanently no matter the number of battery unit replacements.

Preferably, each upgrading module should be provided with an identification code representing the specific design of that particular module, such that the identification code should make it possible to automatically choose the correct module for a specified tool application.

1. Battery energized portable power tool, comprising:
an electric motor,
a housing provided with a connection device for engagement with a matching connection device on a replaceable battery unit, and
a separate upgrading module connectable to the housing and providing additional operational features for adapting the power tool to desired specifications, said upgrading module having on one side thereof a connection device matching said connection device on the housing, and having on another side thereof a connection device matching the connection device on the battery unit said upgrading module being insertable between the housing and the battery unit as required.

2. Power tool according to claim 1, wherein said upgrading module is one of at least two interchangeable upgrading modules all having different setups of accessories to adapt the power tool to desired specifications.

3. Power tool according to claim 2, wherein said upgrading module is arranged to permanently be carried on the tool housing.

4. Power tool according to claim 2, wherein said upgrading module is permanently carried on the battery unit.

5. Power tool according to claim 1, wherein at least one of said at least two interchangeable upgrading modules comprises a transceiver for wireless communication with a stationary control unit.

6. Battery energized portable power tool, comprising:
a housing with an electric motor and a connection device for engagement with a matching connection device on a replaceable battery unit, and
a separate upgrading module connectable to the housing and comprising a transceiver for wireless communication with a stationary control unit, said upgrading module having on one side thereof a first connection device matching said connection device on the housing, and having on another side thereof a second connection device matching the connection device on the battery unit said upgrading module being insertable between the housing and the battery unit as required, and wherein said upgrading module is one of at least two interchangeable upgrading modules all having different setups of additional accessories to meet different power tool specifications.

7. Power tool according to claim 6, wherein said upgrading module is permanently carried on the tool housing.

8. Power tool according to claim 6, wherein said upgrading module is permanently carried on the battery unit.

9. Power tool according to claim 6, wherein said upgrading module comprises a light producing device which illuminates a working area.

10. Power tool according to claim 1, wherein said upgrading module is arranged to permanently be carried on the tool housing.

11. Power tool according to claim 1, wherein said upgrading module is permanently carried on the battery unit.

12. Power tool according to claim 2, wherein at least one of said at least two interchangeable upgrading modules comprises a transceiver for wireless communication with a stationary control unit.

13. Power tool according to claim 3, wherein at least one of said at least two interchangeable upgrading modules comprises a transceiver for wireless communication with a stationary control unit.

14. Power tool according to claim 4, wherein at least one of said at least two interchangeable upgrading modules comprises a transceiver for wireless communication with a stationary control unit.

15. Power tool according to claim 10, wherein at least one of said at least two interchangeable upgrading modules comprises a transceiver for wireless communication with a stationary control unit.

16. Power tool according to claim 11, wherein at least one of said at least two interchangeable upgrading modules comprises a transceiver for wireless communication with a stationary control unit.

17. Power tool according to claim 7, wherein said upgrading module comprises a light producing device which illuminates a working area.

18. Power tool according to claim 8, wherein said upgrading module comprises a light producing device which illuminates a working area.
